(19) United States
(12) Patent Application Publication
(10) Pub. No.: US 2018/0053172 A1
(43) Pub. Date: Feb. 22, 2018

(54) SEAMLESS INTEGRATION OF FINANCIAL INFORMATION WITHIN A MOBILE RETAIL APPLICATION FRAMEWORK

(71) Applicant: Comenity LLC, Columbus, OH (US)

(72) Inventors: David NACK, Bexley, OH (US); Karen LOWE, Nashport, OH (US)

(73) Assignee: Comenity LLC, Columbus, OH (US)

(21) Appl. No.: 15/394,690

(22) Filed: Dec. 29, 2016

Related U.S. Application Data
(60) Provisional application No. 62/376,824, filed on Aug. 18, 2016.

(51) Int. Cl. G06Q 20/32; G06Q 40/02

(52) U.S. Cl. CPC G06Q 20/3221; G06Q 40/02; G06Q 20/3223

(57) ABSTRACT

A system and method for seamless integration of financial information within a mobile retail application framework is described. The system launches a retail application, the retail application interacting with a retail application server to obtain retail information to populate the retail application. The system receives, from within the retail application, a request to view information of a credit account associated therewith. A financial plugin is launched to interact with a financial server, the financial server distinct from the retail application server, the financial server having access to the information of the credit account. The system receives, to the financial plugin from the financial server, the information of the credit account. The information of the credit account from the financial plugin are presented within a framework of the retail application without providing the retail application with access thereto.

### CROSS-REFERENCE

This application claims priority to and benefit of co-pending U.S Provisional Patent Application No. 62/376,824 filed on Aug. 18, 2016, entitled “SEAMLESS INTEGRATION OF FINANCIAL INFORMATION WITHIN A MOBILE RETAIL APPLICATION FRAMEWORK” by David Nack et al., and assigned to the assignee of the present application, the disclosure of which is hereby incorporated herein by reference in its entirety.

### BACKGROUND

Companies often use their websites and mobile applications to promote customer shopping, loyalty, sales, and related interaction. The website and mobile applications will include shopping hours for their brick-and-mortar stores, advertisements, coupons, rewards information, specials, directions, locations, and the like. When a customer accesses the website or application on a large screen such as a desktop screen, laptop screen, notepad screen, tablet screen or the like, the website or application can provide significant user interaction. For example, numerous different web pages can be opened by the customer, e.g., links from within the website or application can open new tabs, different windows, or the like. Moreover, these actions may depend upon customer settings and the like.

However, on a smaller device, such as a mobile device, e.g., where real estate on the computing device screen is limited, there is a need to provide the customer information without numerous pop-ups, tabs, pages, and the like.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 depicts a system for seamless integration of financial information within a mobile retail application framework in accordance with an embodiment.

FIG. 2 is a diagram of a plurality of mobile device screenshots illustrating the seamless integration of financial information within a mobile retail application framework in accordance with an embodiment.

FIG. 3 depicts a flow diagram for a method for seamless integration of financial information within a mobile retail application framework in accordance with an embodiment.

FIG. 4 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure information of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “correlating”, “prescreening”, “developing”, “presenting” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview

Seamless integration of financial information within a mobile retail application framework is discussed herein. When it comes to consumer privacy a financial institution, such as a bank or the like, must operate within the constraints of a number of rules, laws and statutes. Additionally, these rules, laws and statutes can differ by country, state, county, and city. Moreover, the rules, laws and statutes can and do change over time. As such, the financial information cannot be stored in the same data warehouses as those used by retailers. Moreover, the information accessible by a retailer's application stored at a retailer's database is legally limited to not include the customer's financials.

Thus, by regulation, financial institutions cannot hand over functionality to outside servers even via API's and SDK's. In other words, in the banking/financial industry, regulations control what portions of functions or proxies can be unloaded from the financial side to the customer side. As a result financial institutions are not able to use conventional practices such as API's, SDK's or the like to provide in-app functionality. I

Embodiments described herein create a financial functionality that plugs into an existing native retailer application to give the customer a seamless experience. For example, if the customer is using the retailer application, they can seamlessly transition to related financial data such as their credit balance, transaction history, rewards certificates, or the like. These aspects of financial data can include shopping data, account management information, available offers, or other functionality which the consumer receives from their financial account.

When using the plugin, from the customer or retailer perspective the app will appear to be a single application, e.g., seamless. However, from the financial institution's and retail server's actual underlying operation, the portion of the financial information provided by the plugin will actually be provided by financial server 120 and not available to the retail application including the underlying retail application server 110 that the retailer application is utilizing. In other words, the technology is not an application program interface (API) or a software development kit (SDK) as they do not meet the regulatory requirements necessary to maintain the financial information separation/compartmentalization. Instead, the plugin is used in order to comply with the regulations and maintain the proper separation/compartmentalization/security of the customer financial information.

Importantly, the embodiments of the present invention, as will be described below, provide an approach for seamless integration of financial information within a mobile retail application framework which differs significantly from the conventional processes used by native applications. In conventional approaches, the application has access to all of the data being ported through it. Here, the present embodiments, as will be described and explained below in detail, provide a previously unknown procedure to protect the financial information from the application while allowing the information to be displayed within the framework of the application, e.g., from request for financial information, through presentation of the received information. Moreover, the present embodiments provide real-time presentation of the financial information from within the framework of the underlying native application via the plugin. Thus, embodiments of the present invention provide an approach for seamless integration of financial information within a mobile retail application framework which extends well beyond what was previously done by hand.

As will be described in detail, the various embodiments of the present invention do not merely implement conventional retail application processes on a computer. Instead, the various embodiments of the present invention, in part, provide a previously unknown procedure to seamlessly integrate financial information within a mobile retail application framework. Moreover, the present embodiments provide the integrated financial information within a mobile retail application framework without providing the financial information stored on financial server 120 from being accessed by retail application server 110 providing any information to the retailer's application. Hence, embodiments of the present invention provide a novel process for seamless integration of financial information within a mobile retail application framework which is necessarily rooted in computer technology to overcome a problem specifically arising in the realm of real-time financial information and retailer information collaboration for a shared customer.

Moreover, the embodiments do not recite a mathematical algorithm; nor do they recite a fundamental economic or longstanding commercial practice. Instead, they address a business challenge of accurate and timely seamless integration of financial information within a mobile retail application framework. Thus, the embodiments do not “merely recite the performance of some business practice known from the pre-Internet world along with the requirement to perform it on the Internet.” Instead, the embodiments are necessarily rooted in retail and financial technology in order to overcome a problem specifically arising in the realm of seamless integration of financial information within a mobile retail application framework.

### Operation

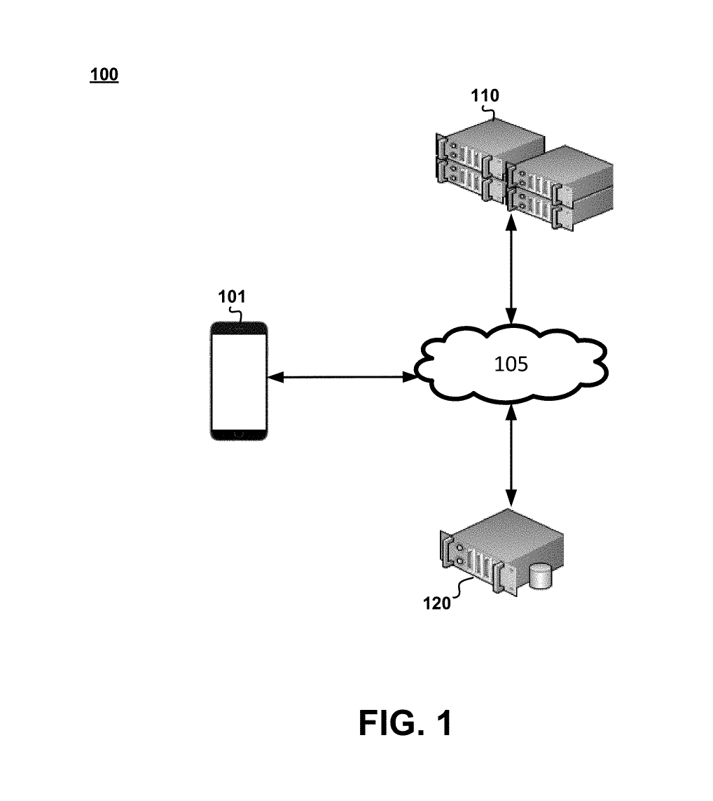

With reference now to FIG. 1 a system 100 for seamless integration of financial information within a mobile retail application framework is shown in accordance with an embodiment. System 100 includes a mobile device 101, a retail application server 110 and a financial server 120. System 100 further includes network 105 which is a wireless communication network such as the Internet, WiFi, Cellular, Bluetooth, NFC, and the like.

For purposes of the discussion, mobile device 101 may be a mobile phone, a smart phone, a tablet, a smart watch, a piece of smart jewelry, smart glasses, or other user portable computational devices having wireless connectivity. That is, mobile device 101 would be capable of broadcasting and receiving via network 105. In one embodiment, mobile device 101 may have a positioning determining system. In another embodiment, mobile device 101 may be able to determine location within a given radius, such as the broadcast range of a beacon, WiFi hotspot, overlapped area covered by a plurality of mobile telephone signal providers, or the like. In general, mobile device 101 will have an operating system and one or more application operating thereon.

Retail application server 110 maintains retail information such as sales, inventory, locations, and the like. Moreover, retail application server 110 maintains customer information such as purchase information, order history, rewards points, loyalty rewards, savings offers, coupons, location information, goods searches, and the like. The application etc. In one embodiment, the mobile retail application on mobile device 101 accesses retail application server 110 via network 105.

Financial server 120 provides client information such as, information may include financial data such as their credit balance, remaining credit available, transaction history, rewards certificates, money spent this month, prior purchases, and the like. In one embodiment, the mobile retail application on mobile device 101 accesses financial server 120 on a secure channel via network 105.

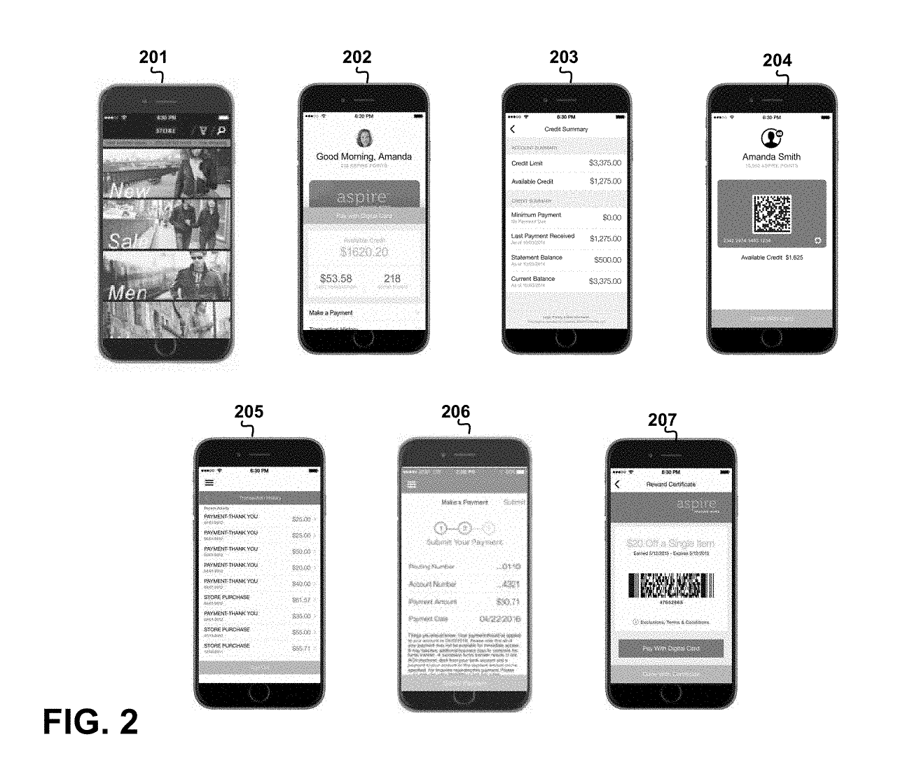

Referring now to FIG. 2, a diagram of a plurality of mobile device 101 screenshots illustrating the seamless integration of financial information within a mobile retail application framework is shown in accordance with an embodiment. Although a plurality of screenshots is shown, it should be appreciated that the screenshots are provided for purposes of example and clarity. It is possible that one or more of the screenshots may differ in information from what is actually shown based on personal preference, legislation, retail application preference and the like.

In general, screenshot 201 shows a retailer mobile application homepage as presented on mobile device 101. Screenshot 202 illustrates a secure financial home page as presented by the financial plugin within the framework of the retail mobile application on mobile device 101. Screenshot 203 is a secure credit summary page as presented by the financial plugin within the framework of the retail mobile application on mobile device 101. Screenshot 204 shows a digital credit “card” within the framework of the retail mobile application as presented on mobile device 101. Screenshot 205 illustrates a secure financial transaction history page as presented by the financial plugin within the framework of the retail mobile application on mobile device 101. Screenshot 206 is a secure financial bill payment page as presented by the financial plugin within the framework of the retail mobile application on mobile device 101. Screenshot 207 illustrates a digital reward certificate presented by the retail mobile application on mobile device 101.

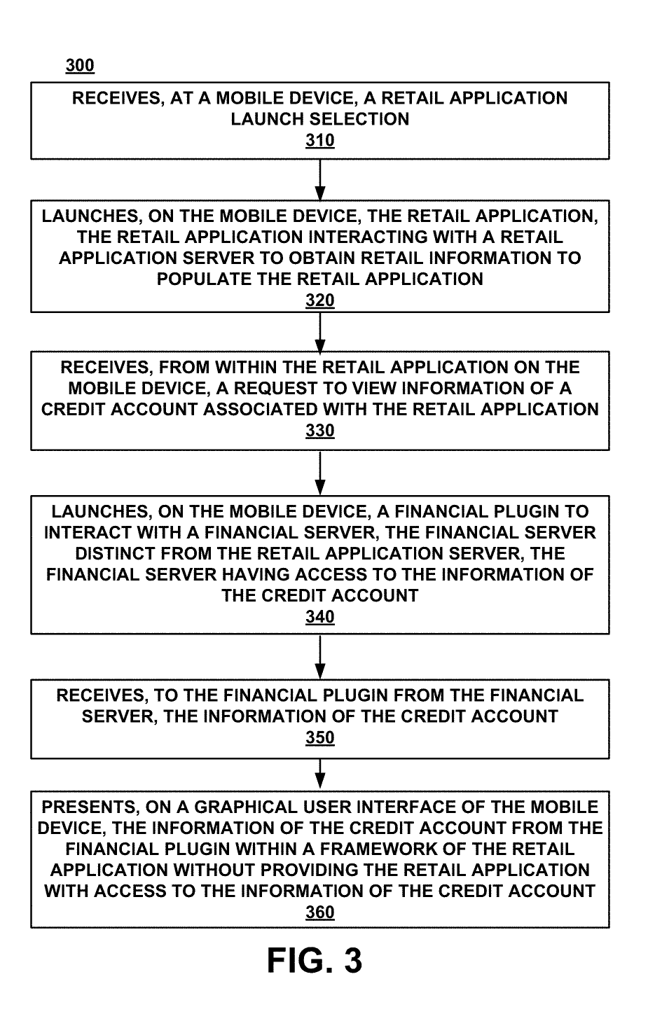

With reference now to FIG. 3, a flow diagram 300 of a method for seamless integration of financial information within a mobile retail application framework is shown. With reference now to 310 of FIG. 3, one embodiment receives, at mobile device 101, a retail application launch selection. For example, a user may have a mobile retail application for a certain company, e.g., David's tool shed. The mobile retail application allows a customer to receive offers, find coupons, search for goods, and the like. The application can access retail application server 110 to provide purchase information, order history, rewards points, loyalty rewards, savings offers, coupons, etc. For example, if a user was thinking about some tools, the user could open the application and browse David's offers, sales, inventory, locations, etc. Similarly, if the user was at David's tool shed, they could open or launch the application while at the store to see offers, coupons, shopping needs, provide customer rewards number, checkout information to a point of sale (POS), etc.

Moreover, in one embodiment, mobile device 101 may automatically open the application when the device is within a proximal location to David's tool shed. For example, mobile device 101 may have a positioning determining system or be able to determine location within a given radius, such as the broadcast range of a beacon, WiFi hotspot, overlapped area covered by a plurality of mobile telephone signal providers, or the like. The application would have a geo-fence or the like that would automatically launch the application on mobile device 101 when the user was within a certain range that may be user definable. For example, the range may be, when entering David's tool shed; 100 feet therefrom, e.g., in the parking lot; 500 meters therefrom, e.g., in the mall; within 2 miles thereof; or the like.

Referring now to 320 of FIGS. 3 and 201 of FIG. 2, one embodiment launches, on mobile device 101, the retail application, the retail application interacting with a retail application server 110 to obtain retail information to populate the retail application. For example, the mobile retail application will allow a customer to receive offers, find coupons, search for goods, and the like. The application can provide purchase information, location information, order history, rewards points, loyalty rewards, savings offers, coupons, and the like. In one embodiment, the retail application server may be client specific, e.g., David's tool shed's retail application server or a plurality of David's tool shed's retail application servers. In another embodiment, the retail application server may support a number of different clients with different applications, one of them being David's tool shed.

With reference now to 330 of FIG. 3, one embodiment receives, from within the retail application on mobile device 101, a request to view information of a credit account associated with the retail application. In one embodiment, the information may include financial data such as their credit balance, transaction history, rewards certificates, or the like. For example, a user will have David's tool shed mobile application and a store-branded credit account from Karen's financial kingdom. When the user wants to see their credit account information for Karen's financial kingdom they would select a link, click a button, select from a menu, or the like.

With reference now to 340 of FIG. 3, one embodiment launches, on mobile device 101, a financial plugin to interact with financial server 120, financial server 120 distinct from the retail application server, financial server 120 having access to the information of the credit account. For example, financial server 120 would be under the control of Karen's financial kingdom, which would be distinct from retail application server 110. Launching the financial plugin would cause the financial plugin to access financial server 120. The access would be performed by the plugin and not by the underlying application. The financial plugin would then access the server of Karen's financial kingdom, authenticate the user and provide a secure communications path.

Referring now to 350 of FIGS. 3 and 202-207 of FIG. 2, one embodiment receives, to the financial plugin from financial server 120, the information of the credit account. In one embodiment, the information from the credit account may include, but is not limited to, one or more of a user's credit account homepage (202 of FIG. 2), a user's purchase history (205 of FIG. 2), a user's remaining credit balance (203 of FIG. 2), a user's rewards information (207 of FIG. 2), a bill payment option (206 of FIG. 2), a user's credit account virtual card (204 of FIG. 2), and the like. In other words, once the plugin is authenticated and a secure communications path is established between financial server 120, e.g., of Karen's financial kingdom, and the user's mobile device 101, the plugin on the application would provide a window into the information from the credit account. In one embodiment, the information initially presented may be a default screen such as a credit balance, remaining credit available, or the like. In another embodiment, the information initially presented may be customized by the user, e.g., money spent this month, prior purchases, balance, etc.

With reference now to 360 of FIG. 3, one embodiment presents, on a graphical user interface of mobile device 101, the information of the credit account from the financial plugin within a framework of the retail application without providing the retail application with access to the information of the credit account. That is, the credit account information would be presented to the user without having to open a second application, in a different tab or window, or the like. Instead, the credit account information would be presented to the user seamlessly from within the retail application. It would become part of the menu, displayed in the same frame as the underlying retail application, and the like.

Thus, when using the plugin, from the customer or retailer perspective the app will appear to be a single application, e.g., seamless. However, although the information from the financial plugin would be presented as though it were part of the retail application, from the financial institution's and retail server's actual underlying operation; the portion of the financial information provided by the plugin will actually be provided by financial server 120. That is, it will not be available to the retail application including the underlying retail application server 110 that the retailer application is utilizing.

In other words, the technology is not an application program interface (API) or a software development kit (SDK) as they do not meet the regulatory requirements necessary to maintain the financial information separation/compartmentalization. Instead, the plugin is used in order to comply with the regulations and maintain the proper separation/compartmentalization/security of the customer financial information.

In addition, the technology is well suited to utilize the information of the credit account in conjunction with a purchase request of the retail application to adjust a user's credit limit based on the purchase request. For example, if a user is looking at purchasing something for 500 dollars but has less than 500 dollars in credit remaining on their account. The application may work with the financial plugin to determine the difference and perform a credit reevaluation. In so doing, the result of the credit reevaluation may be an increase in the user's credit limit to allow a purchase of a product at an amount higher than a user's present credit limit. That is, the application in conjunction with the financial plugin could determine that the user would be able to receive an increase in the credit limit. In general, the determination may be based on a credit check, the user's credit history with the information provided in the financial plugin, an intended credit increase by the financial services accessed by the financial plugin, and the like.

Moreover, in one embodiment, the retail application and plugin will allow the user to use their credit account to make a purchase via the retail application without requiring the user to present their plastic card. Similarly, the user would not be required to use mobile pay that includes transfer of information between mobile device 101 and the POS at the checkout. Instead, the payment portions of the checkout would be performed completely within the application running on the user's mobile device 101.

Thus, embodiments described herein create a financial functionality that plugs into an existing native retailer application to give the customer a seamless experience. For example, if the customer is using the retailer application, they can seamlessly transition to related financial data such as their credit balance, transaction history, rewards certificates, or the like. These aspects of financial data can include shopping data, account management information, available offers, or other functionality which the consumer receives from their financial account.

### Android Plugin Integration

The distribution of the plugin provides a turnkey solution to retailers while ensuring that the communication and data storage of financial information meets all standards, statutes and requirements. The plugin provides the end user with the account center core services that can fit seamlessly into most app experiences. The following is one embodiment which can be used by developers to integrate the Plugin into their app.

The description provided herein for Integrating the Plugin is directed toward the following: Android Studio with Gradle version 1.2+, Android 2.3 (API Level 9) or greater; Note that when running the plugin on versions less than Android 4.0 (API Level 14), some functionality may be lost.

### Obtaining and Integrating the Plugin

To obtain and integrate the plugin via Gradle, add the following repository section to the app's build.gradle file.

```
repositories {
      maven {
            url ‘http://msl.dist.mycardcare.com:8080/repository/internal’
      }
}
```

Then, add the following dependencies to the build.gradle file:
compile ‘com.alliancedata:accountcenter:1.0’

To obtain and integrate the plugin manually, download the latest release ZIP or tarball from: <insert url here>. Unzip the archive. Copy the extracted accountcenter.aar file into the app/libs directory in the application.

Add the libs directory as a flatdir to the top-level repositories section of the app's build.gradle file:

```
repositories {
      flatDir {
            dirs ‘libs’
      }
}
```

Add the following to dependencies (where accountcenter is the .aar file name) in build.gradle to compile the aar:
compile(name: ‘accountcenter’, ext: ‘aar’)

### Using the Plugin

Once the plugin and following dependencies have been included in gradle, make sure that a project sync and build complete successfully. The plugin can be added to the host application using the AllianceNPI fragment. Use the following code to launch the fragment (the items in bold should be changed appropriately per integration):

```
import android.support.v4.app.Fragment;
import android.support.v4.app.FragmentManager;
import android.support.v4.app.FragmentTransaction;
@Override
public View onCreateView(LayoutInflater inflater, ViewGroup
                          container, Bundle savedInstanceState) {
        AllianceNPI NACFragment =
              AllianceNPI.newInstance(Environment.PROD,“<insert
retailer name>”, “<insert api key>”);
        FragmentTrasaction fragmentTransaction =
                                      getFragmentManager( ).
                                      beginTransaction( );
        fragmentTransaction.replace(R.id.container_body,
        NACFragment);
        fragmentTransaction.commit( )
        return view;
}
```

To use the NAC as a standalone fragment use a fragmentTransaction.add instead of replace.

```
import android.support.v4.app.Fragment;
import android.support.v4.app.FragmentManager;
import android.support.v4.app.FragmentTransaction;
      AllianceNPI fragment = null;
      @Override
      protected void onCreate(Bundle savedInstanceState) {
            super.onCreate(savedInstanceState);
            setContentView(R.layout.activity_main);
            AllianceNPI NACFragment =
                  AllianceNPI.newInstance(Environment.PROD,“
<insert retailer name>”, “<insert api key>”);
      FragmentManager fragmentManager =
      getSupportFragmentManager( );
      FragmentTransaction fragmentTransaction =
                        fragmentManager.beginTransaction( );
      fragmentTransaction.add(android.R.id.content, NACFragment);
      fragmentTransaction.commit( );
}
Back Button
```

To properly handle hardware back button presses within the plugin, control must be passed to the plugin from the Activity instance in the app.

```
@Override
      public boolean onKeyDown(int keyCode, KeyEvent event) {
            Boolean retVal =
            FragmentController.handleBackButton(keyCode, event);
            if(!retVal) {
                  retVal = super.onKeyDown(keyCode, event);
            }
            return retVal;
}
```

### Supported Orientations

The Financial Plugin supports portrait orientation only. Be sure to add:

android:screenOrientation=“portrait” to the activity configuration in the manifest that will launch the fragment containing the Plugin.

### Tabbed Views

To show the NAC in a tabbed view which uses ViewPager, set off screen page limit to be the total number of tabs in the app.
ViewPagersetOffscreenPageLimit(number_of_tabs);

### Sizing the Container

The NAC's container inside the client app should be kept at a consistent size and should not resize when the keyboard is present. One option is to use something similar to the code below within the AndroidMaifest.xml for the activity which is hosting the NAC. android:windowSoftInputMode=“adjustPan”

*Note this is not always required but is needed in most cases.

### Destroying the Alliancenpi Fragment

In some instances it will become necessary to call the onDestroy method for the AllianceNPI in order for the user state to be maintained. If there are no issues with maintaining the user state then this section of integration may be unnecessary.

One situation when this could be necessary is when creating the AllianceNPI fragment from another fragment. When the host fragment is destroyed the AllianceNPI's lifecycle methods do not get executed.

To remedy this add the below section to the host fragment.

```
      @Override
            public void onDestroy( ) {
                  super.onDestroy( );
                  if(allianceNPIFragment != null &&
allianceNPIFragment.getActivity( ) != null){
                        allianceNPIFragment.onDestroy( );
                  }
      }
```

### Proguard

Proguard should be used when creating a release version of the plugin. Here is a proguard configuration that can be used to minify and obscure the plugin while retaining appropriate class names.

### Proguard Configuration

```
-dontwarn ads.com.squareup.okhttp.internal.huc.HttpsURLConnectionImpl
-dontwarn com.squareup.**
-dontwarn ads.okio.**
-keep class com.google.android.gms.wearable.** { *; }
-dontwarn com.google.android.gms.wearable.**
-keep class com.google.android.gms.common.** { *; }
-dontwarn com.google.android.gms.common.**
-keep class com.jakewharton.disklrucache.** { *; }
-dontwarn com.jakewharton.disklrucache.**
-keep class javax.naming.** { *; }
-dontwarn javax.naming.**
-keep class org.spongycastle.pqc.asn1.PQCObjectIdentifiers
-dontwarn org.spongycastle.pqc.asn1.PQCObjectIdentifiers
-keep class org.spongycastle.pqc.crypto.gmss.GMSSPublicKeyParameters
-dontwarn org.spongycastle.pqc.crypto.gmss.GMSSPublicKeyParameters
-keep class org.spongycastle.pqc.crypto.gmss.GMSSParameters
-dontwarn org.spongycastle.pqc.crypto.gmss.GMSSParameters
-keep class org.spongycastle.pqc.asn1.ParSet
-dontwarn org.spongycastle.pqc.asn1.ParSet
-keep class org.spongycastle.pqc.asn1.GMSSPublicKey
-dontwarn org.spongycastle.pqc.asn1.GMSSPublicKey
-keep class org.spongycastle.pqc.crypto.mceliece.McEliecePointchevalCipher
-dontwarn org.spongycastle.pqc.crypto.mceliece.McEliecePointchevalCipher
-keep class org.spongycastle.pqc.crypto.mceliece.McElieceCCA2KeyParameters
-dontwarn org.spongycastle.pqc.crypto.mceliece.McElieceCCA2KeyParameters
-keep class org.spongycastle.pqc.asn1.McEliecePublicKey
-dontwarn org.spongycastle.pqc.asn1.McEliecePublicKey
-keep class org.spongycastle.pqc.asn1.McEliecePrivateKey
-dontwarn org.spongycastle.pqc.asn1.McEliecePrivateKey
-keep class org.spongycastle.pqc.asn1.RainbowPublicKey
-dontwarn org.spongycastle.pqc.asn1.RainbowPublicKey
-keep class org.spongycastle.pqc.asn1.RainbowPrivateKey
-dontwarn org.spongycastle.pqc.asn1.RainbowPrivateKey
-keep class org.spongycastle.pqc.crypto.rainbow.util.RainbowUtil
-dontwarn org.spongycastle.pqc.crypto.rainbow.util.RainbowUtil
-keep class org.spongycastle.pqc.crypto.rainbow.RainbowKeyPairGenerator
-dontwarn org.spongycastle.pqc.crypto.rainbow.RainbowKeyPairGenerator
-keep class org.spongycastle.pqc.crypto.rainbow.RainbowKeyGenerationParameters
-dontwarn org.spongycastle.pqc.crypto.rainbow.RainbowKeyGenerationParameters
-keep class org.spongycastle.pqc.crypto.rainbow.RainbowParameters
-dontwarn org.spongycastle.pqc.crypto.rainbow.RainbowParameters
-keep class org.spongycastle.pqc.crypto.rainbow.RainbowPublicKeyParameters
-dontwarn org.spongycastle.pqc.crypto.rainbow.RainbowPublicKeyParameters
-keep class org.spongycastle.pqc.crypto.rainbow.RainbowPrivateKeyParameters
-dontwarn org.spongycastle.pqc.crypto.rainbow.RainbowPrivateKeyParameters
-keep class org.spongycastle.pqc.crypto.rainbow.RainbowSigner
-dontwarn org.spongycastle.pqc.crypto.rainbow.RainbowSigner
-keep class org.spongycastle.pqc.crypto.gmss.**
-dontwarn org.spongycastle.pqc.crypto.gmss.**
-keep class org.spongycastle.pqc.math.linearalgebra.**
-dontwarn org.spongycastle.pqc.math.linearalgebra.**
-keep class org.spongycastle.pqc.crypto.rainbow.Layer
-dontwarn org.spongycastle.pqc.crypto.rainbow.Layer
-keep class org.spongycastle.pqc.crypto.mceliece.McElieceCCA2PrivateKeyParameters
-dontwarn org.spongycastle.pqc.crypto.mceliece.McElieceCCA2PrivateKeyParameters
-keep class org.spongycastle.pqc.asn1.McElieceCCA2PrivateKey
-dontwarn org.spongycastle.pqc.asn1.McElieceCCA2PrivateKey
---keep class org.spongycastle.pqc.crypto.mceliece.McElieceCCA2Parameters
-dontwarn org.spongycastle.pqc.crypto.mceliece.McElieceCCA2Parameters
-keep class org.spongycastle.pqc.crypto.mceliece.McElieceCCA2PublicKeyParameters
-dontwarn org.spongycastle.pqc.crypto.mceliece.McElieceCCA2PublicKeyParameters
-keep class org.spongycastle.pqc.asn1.McElieceCCA2PublicKey
-dontwarn org.spongycastle.pqc.asn1.McElieceCCA2PublicKey
-keep class org.spongycastle.pqc.crypto.mceliece.McEliecePrivateKeyParameters
-dontwarn org.spongycastle.pqc.crypto.mceliece.McEliecePrivateKeyParameters
-keep class org.spongycastle.pqc.crypto.mceliece.McElieceParameters
-dontwarn org.spongycastle.pqc.crypto.mceliece.McElieceParameters
-keep class org.spongycastle.pqc.crypto.mceliece.McElieceCCA2KeyPairGenerator
-dontwarn org.spongycastle.pqc.crypto.mceliece.McElieceCCA2KeyPairGenerator
-keep class org.spongycastle.pqc.crypto.mceliece.McElieceCCA2KeyGenerationParameters
-dontwarn org.spongycastle.pqc.crypto.mceliece.McElieceCCA2KeyGenerationParameters
-keep class org.spongycastle.pqc.crypto.mceliece.McEliecePKCSCipher
-dontwarn org.spongycastle.pqc.crypto.mceliece.McEliecePKCSCipher
-keep class org.spongycastle.pqc.crypto.mceliece.McEliecePublicKeyParameters
-dontwarn org.spongycastle.pqc.crypto.mceliece.McEliecePublicKeyParameters
-keep class org.spongycastle.pqc.crypto.mceliece.McElieceFujisakiCipher
-dontwarn org.spongycastle.pqc.crypto.mceliece.McElieceFujisakiCipher
-keep class org.spongycastle.pqc.crypto.mceliece.McElieceKeyPairGenerator
-dontwarn org.spongycastle.pqc.crypto.mceliece.McElieceKeyPairGenerator
-keep class org.spongycastle.pqc.crypto.mceliece.McElieceKeyGenerationParameters
-dontwarn org.spongycastle.pqc.crypto.mceliece.McElieceKeyGenerationParameters
-keep class org.spongycastle.pqc.crypto.mceliece.McElieceKobaraImaiCipher
-dontwarn org.spongycastle.pqc.crypto.mceliece.McElieceKobaraImaiCipher
-keep class org.spongycastle.pqc.crypto.mceliece.McElieceKeyParameters
-dontwarn org.spongycastle.pqc.crypto.mceliece.McElieceKeyParameters
-keep class org.spongycastle.jce.provider.PKIXCertPathValidatorSpi
-dontwarn org.spongycastle.jce.provider.PKIXCertPathValidatorSpi
-keep class javax.annotation.Nullable
-dontwarn javax.annotation.Nullable
-keep class javax.annotation.CheckReturnValue
-dontwarn javax.annotation.CheckReturnValue
-keep class javax.annotation.concurrent.GuardedBy
-dontwarn javax.annotation.concurrent.GuardedBy
-keep class javax.annotation.ParametersAreNonnullByDefault
-dontwarn javax.annotation.ParametersAreNonnullByDefault
-keep class com.google.appengine.api.urlfetch.HTTPMethod
-dontwarn com.google.appengine.api.urlfetch.HTTPMethod
-keep class com.google.appengine.api.urlfetch.URLFetchServiceFactory
-dontwarn com.google.appengine.api.urlfetch.URLFetchServiceFactory
-keep class com.google.appengine.api.urlfetch.URLFetchService
-dontwarn com.google.appengine.api.urlfetch.URLFetchService
-keep class com.google.appengine.api.urlfetch.HTTPHeader
-dontwarn com.google.appengine.api.urlfetch.HTTPHeader
-keep class com.google.appengine.api.urlfetch.HTTPRequest
-dontwarn com.google.appengine.api.urlfetch.HTTPRequest
-keep class com.google.appengine.api.urlfetch.HTTPResponse
-dontwarn com.google.appengine.api.urlfetch.HTTPResponse
-keep class javax.annotation.concurrent.Immutable
-dontwarn javax.annotation.concurrent.Immutable
-keep class javax.annotation.CheckForNull
-dontwarn javax.annotation.CheckForNull
-keep class javax.annotation.concurrent.NotThreadSafe
-dontwarn javax.annotation.concurrent.NotThreadSafe
-keep class com.squareup.okhttp.internal.huc.HttpURLConnectionImpl
-dontwarn com.squareup.okhttp.internal.huc.HttpURLConnectionImpl
-keep class java.nio.file.Files
-dontwarn java.nio.file.Files
-keep class java.nio.file.Path
-dontwarn java.nio.file.Path
-keep class java.nio.file.OpenOption
-dontwarn java.nio.file.OpenOption
-keep class javax.annotation.concurrent.ThreadSafe
-dontwarn javax.annotation.concurrent.ThreadSafe
-keep class org.codehaus.mojo.animal_sniffer.IgnoreJRERequirement
-dontwarn org.codehaus.mojo.animal_sniffer.IgnoreJRERequirement
-keep class org.apache.commons.io.IOUtils
-dontwarn org.apache.commons.io.IOUtils
-keep class com.google.gson.** { *; }
-keep class com.google.inject.* { *; }
-keep class org.apache.http.* { *; }
-keep class org.apache.james.mime4j.* { *; }
-keep class javax.inject.* { *; }
-keep class retrofit.** { *; }
-keepclasseswithmembers class * {
@retrofit.http.* <methods>;
}
-keep class rx.subscriptions.Subscriptions
-dontwarn rx.subscriptions.Subscriptions
-dontwarn rx.**
-keepattributes Signature
-keepattributes *Annotation*
-keep class sun.misc.Unsafe { *; }
-dontwarn sun.misc.Unsafe
# App
-keep class com.alliancedata.** { *; }
-keep class com.squareup.** { *; }
-keep class ads.** { *; }
-keepnames class com.alliancedata.**
-keepnames class com.squareup.**
-keepnames class ads.**
-keepclassmembers class com.alliancedata.** {
      <init>(android.app.Activity, int);
}
-keepclassmembers class * {
      @javax.inject.* <fields>;
}
-keepclasseswithmembernames class * {
      @javax.inject.* <fields>;
            @javax.inject.* <init>(...);
}
# Keep the generated classes by dagger---compile
-keep class **$$ModuleAdapter
-keep class **$$InjectAdapter
-keep class **$$StaticInjection
-keep class android.transition.Transition
-assumenosideeffects class android.util.Log {
      public static boolean isLoggable(java.lang.String, int);
      public static int v(...);
      public static int i(...);
      public static int w(...);
      public static int d(...);
      public static int e(...);
}
```

### iOS Plugin Integration

The description provided herein for Integrating the Plugin is directed toward the following: Xcode 7.1 or greater, an app targeted to iOS 8 or greater.

### Obtaining and Integrating the Plugin Manually

Download the latest release ZIP or tarball from: https://msl.test2.mycardcare.com/files/beta/ios/ and unzip the archive.

Drag and drop the following files into the Xcode project:
libAD SAccountCenter. a
AD SAccountCenter.h
AD SAccountCenter.bundle

Go to the “Build Phases” tab of the project settings and ensure that libADSAccountCenter.a is listed in the “Link Binary with Libraries” section with mode set to “Required”. If not, click the “+” icon and add them. Next and the following Binaries:
AssetsLibrary.framework, Accounts. framework, AudioToolBox.framework,
AVFoundation.framework, CoreMedia.framework, CoreVideo.framework,
CFNetwork.framework, CoreGraphics.framework, CoreLocation.framework,
ImageIO.framework, libsqllite3.dylib, libz.dylib, MobileCoreServices.framework,
QuartzCore.framework, Security.framework, Social.framework,
SystemConfiguration.framework, and Twitter.framework. Finally select the project target in Xcode. Then select Build Settings and search for Other Linker Flags and add, if needed, the—ObjC flag. At this point, one should be able to compile and link to the static library.

### Using the Plugin

Once the Plugin has been integrated with the Xcode workspace, verify Xcode can compile, link and run (in the iOS Simulator).

### Source Integration

Import the following headers:

#import<ADSAccountCenter/ADSAccountCenter.h>into any class which will access the Plugin. Particularly, the AppDelegate will need the headers imported.

### Initializing the Plugin

Setup the Plugin in the Application's AppDelegate. Insert the following code into application:DidFinishLaunchingWithOptions: in the AppDelegate:

```
NSError *error = nil;
ADSAccountCenterConfigurationType envType = <environment to use>;
NSString *retailerName = @“<client name>”;
NSString *retailerApiKey = @“<retailer API key>”;
NSString *retailerConsumerApiKey = @“<retailer consumer API key>”;
[ADSAccountCenter setupWithConfiguration:envType
            forRetailer:retailerName
          retailerAPIKey:retailerApiKey
      retailerConsumerAPIKey:retailerConsumerApiKey
                  error:&error];
```

The above method must be called immediately during application:DidFinishLaunchingWithOptions: in the AppDelegate. This is a requirement of the Plugin.

Note that the retailerConsumerAPlKey is the Application Analytics ID from Omniture. This is a value that should be provided for integration. Additionally, this value should be different for the various environments.

The Plugin can be queried to ask whether it is setup by calling:
+(BOOL)isSetup;

### Presenting the Plugin

Once the Plugin is known to be setup, it can be presented to the user via two different methodologies: full-screen, or embedded inside of a container view. The full screen method is for apps that want the Plugin experience to be full-screen until the user touches a “Back” button. The embedded mode is for embedding inside of another View or View Controller, such as a UITabBarController, etc.

To present the Plugin in a full-screen experience, use the following:
+(void)presentInWindow:(UIWindow *)window;

To present the Plugin in an embedded view, use the following method in viewDidAppear or viewWillAppear of the view controller embedding the view:
+(void)embedInContainerView:(UIView *)containerView withParentViewController:(UIViewController *)viewController;

This method assumes that the containerView parameter is a subclass of UIView that is contained as a subview of the viewController parameter.

Important:

For this to display properly, it must be done on a container view that is fully laid out.

Calling this the first time (only the first time) viewDidAppear or viewWillAppear is called for the view controller.

Embedded views should use a view that is pinned to the edges of the view controller's top-level view.

Note: Both of these methods should only ever be called once, and additionally, they are mutually exclusive. Only one of these methods should ever be called in an application.

Be sure to import the Account Center headers into the class which will use either the presentlnWindow or embedlnContainerView to manage the presentation:
#import<ADSAccountCenter/ADSAccountCenter.h

### Submitting to the App Store

When submitting to the App Store, an Entitlements error may be received. This is due to the fact that the user must codesign the ADS Account Center bundle themself. To fix this error, delete ADSAccountCenter from within the ADSAccountCenter.bundle. This will cause Xcode to codesign properly and should enable App Store submissions.

### Example Computer System

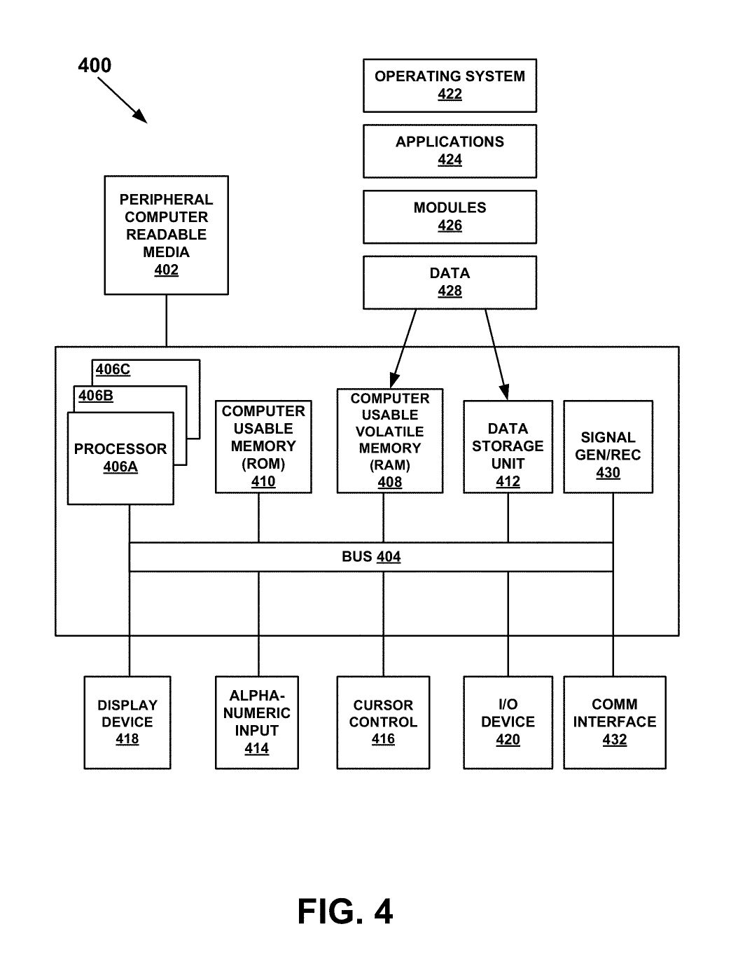

With reference now to FIG. 4, a block diagram of an example computer system with which or upon which various embodiments of the present invention may be implemented is shown. It should be appreciated that one or more of the embodiments may be composed of computer-readable and computer-executable instructions that reside, for example, in a non-transitory computer-readable medium.

Although FIG. 4 illustrates an example computer system 400 used in accordance with embodiments of the present technology. It is appreciated that system 400 of FIG. 4 can operate on or within a number of different computer systems including general purpose networked computer systems, computer-readable and computer-executable instructions that reside, for example, in non-transitory computer-readable medium, embedded computer systems, routers, switches, server devices, user devices, various intermediate devices/artifacts, stand-alone computer systems, mobile phones, personal data assistants, televisions and the like.

Computer system 400 of FIG. 4 is well adapted to having peripheral computer readable media 402 such as, for example, an external storage drive, a compact disc, a flash drive, a thumb drive, a wireless radio enabled device, and the like coupled thereto.

Computer system 400 of FIG. 4 includes an address/data/control bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. Computer system 400 also includes data storage features such as a computer usable volatile memory 408, e.g., random access memory (RAM), coupled to bus 404 for storing information and instructions for processors 406A, 406B, and 406C.

System 400 also includes computer usable non-volatile memory 410, e.g., read only memory (ROM), coupled to bus 404 for storing static information and instructions for processors 406A, 406B, and 406C. Also present in system 400 is a data storage unit 412 (e.g., a magnetic disk drive, optical disk drive, solid state drive (SSD), and the like) coupled to bus 404 for storing information and instructions. Computer system 400 also includes an optional alpha-numeric input device 414 including alphanumeric and function keys coupled to bus 404 for communicating information and command selections to processor 406A or processors 406A, 406B, and 406C. Computer system 400 also includes an optional cursor control device 416 coupled to bus 404 for communicating user input information and command selections to processor 406A or processors 406A, 406B, and 406C. Optional cursor control device may be a touch sensor, gesture recognition device, and the like. Computer system 400 of the present embodiment also includes an optional display device 418 coupled to bus 404 for displaying information.

Referring still to FIG. 4, optional display device 418 of FIG. 4 may be a liquid crystal device, cathode ray tube, OLED, plasma display device or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick, non-contact input, gesture recognition, voice commands, bio recognition, and the like. In addition, special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

Computer system 400 also includes an I/O device 420 for coupling system 400 with external entities. For example, in one embodiment, I/O device 420 is a modem for enabling wired or wireless communications between system 400 and an external network such as, but not limited to, the Internet or intranet. A more detailed discussion of the present technology is found below.

Referring still to FIG. 4, various other components are depicted for system 400. Specifically, when present, an operating system 422, applications 424, modules 426, and data 428 are shown as typically residing in one or some combination of computer usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present technology, for example, is stored as an application 424 or module 426 in memory locations within RAM 408 and memory areas within data storage unit 412. The present technology may be applied to one or more elements of described system 400.

System 400 also includes one or more signal generating and receiving device(s) 430 coupled with bus 404 for enabling system 400 to interface with other electronic devices and computer systems. Signal generating and receiving device(s) 430 of the present embodiment may include wired serial adaptors, modems, and network adaptors, wireless modems, and wireless network adaptors, and other such communication technology. The signal generating and receiving device(s) 430 may work in conjunction with one or more communication interface(s) 432 for coupling information to and/or from system 400. Communication interface 432 may include a serial port, parallel port, Universal Serial Bus (USB), Ethernet port, Bluetooth, thunderbolt, near field communications port, WiFi, Cellular modem, or other input/output interface. Communication interface 432 may physically, electrically, optically, or wirelessly (e.g., via radio frequency) couple system 400 with another device, such as a mobile telephone, radio, or computer system.

The computing system 400 is only one example of a suitable computing environment and is not intended to suggest any limitation as to the scope of use or functionality of the present technology. Neither should the computing environment be interpreted as having any dependency or requirement relating to any one or combination of components illustrated in the example computing system 400.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method for seamless integration of financial information within a mobile retail application framework, the method comprising:
receiving, at a mobile device, a retail application launch selection;
launching, on the mobile device, a retail application, the retail application interacting with a retail application server to obtain retail information to populate the retail application;
receiving, from within the retail application on the mobile device, a request to view information of a credit account associated with the retail application;
launching, on the mobile device, a financial plugin to interact with a financial server, said financial server distinct from said retail application server, the financial server having access to said information of said credit account;
receiving, to the financial plugin from the financial server, the information of the credit account; and
presenting, on a graphical user interface of the mobile device, the information of the credit account from the financial plugin within a framework of the retail application without providing the retail application with access to the information of the credit account.

2. The method of claim 1 wherein the receiving of the information of said credit account comprises:
receiving a user's credit history.

3. The method of claim 1 wherein the receiving of the information of said credit account comprises:
receiving a user's purchase history.

4. The method of claim 1 wherein the receiving of the information of said credit account comprises:
receiving a user's remaining credit balance.

5. The method of claim 1 wherein the receiving of the information of said credit account comprises:
receiving a user's rewards information.

6. The method of claim 1 further comprising:
utilizing the information of said credit account in conjunction with a purchase request of said retail application to adjust a user's credit limit based on said purchase request.

7. The method of claim 6 wherein adjusting a user's credit limit comprises:
increasing the user's credit limit to allow a purchase of a product at an amount higher than a user's present credit limit.

8. One or more devices, comprising:
a memory storing instructions; and
a processor, when executing the instructions, to:
launch a retail application, the retail application interacting with a retail application server to obtain retail information to populate the retail application;
receive, from within the retail application, a request to view information of a credit account associated with the retail application;
launch a financial plugin to interact with a financial server, said financial server distinct from said retail application server, the financial server having access to said information of said credit account;
receive, to the financial plugin from the financial server, the information of the credit account; and
present, on a graphical user interface, the information of the credit account from the financial plugin within a framework of the retail application without providing the retail application with access to the information of the credit account.

9. The one or more devices of claim 8, where the processor, when executing the instructions further to:
access a user's credit history.

10. The one or more devices of claim 8, where the processor, when executing the instructions further to:
access a user's purchase history.

11. The one or more devices of claim 8, where the processor, when executing the instructions further to:
access a user's remaining credit balance.

12. The one or more devices of claim 8, where the processor, when executing the instructions further to:
access a user's rewards information.

13. The one or more devices of claim 8, where the processor, when executing the instructions further to:
utilize the information of said credit account in conjunction with a purchase request of said retail application to adjust a user's credit limit.

14. The one or more devices of claim 13, where the processor, when executing the instructions further to:
increase the user's credit limit to allow a purchase of a product at an amount higher than a user's present credit limit.

15. A non-transitory computer-readable medium for storing instructions, the instructions comprising:
one or more instructions which, when executed by one or more processors, cause one or more processors to:
launch a retail application, the retail application interacting with a retail application server to obtain retail information to populate the retail application;
receive, from within the retail application, a request to view information of a credit account associated with the retail application;
launch a financial plugin to interact with a financial server, said financial server distinct from said retail application server, the financial server having access to said information of said credit account;
receive, to the financial plugin from the financial server, the information of the credit account; and
present, on a graphical user interface, the information of the credit account from the financial plugin within a framework of the retail application without providing the retail application with access to the information of the credit account.

16. The non-transitory computer-readable medium of claim 15, where the instructions further comprise:
one or more instructions to access a user's purchase history.

17. The non-transitory computer-readable medium of claim 15, where the instructions further comprise:
one or more instructions to access a user's remaining credit balance.

18. The non-transitory computer-readable medium of claim 15, where the instructions further comprise:
one or more instructions to access a user's rewards information.

19. The non-transitory computer-readable medium of claim 15, where the instructions further comprise:
one or more instructions to utilize the information of said credit account in conjunction with a purchase request of said retail application to adjust a user's credit limit.

20. The non-transitory computer-readable medium of claim 19, where the instructions further comprise:
one or more instructions to increase the user's credit limit to allow a purchase of a product at an amount higher than a user's present credit limit.
